(19) United States
(12) Patent Application Publication
(10) Pub. No.: US 2014/0329400 A1
(43) Pub. Date: Nov. 6, 2014

(54) LOCK DEVICE

(71) Applicants: Masashi Kakizaki, Aichi (JP); Masaru Sasaki, Toyota-shi (JP)

(72) Inventors: Masashi Kakizaki, Aichi (JP); Masaru Sasaki, Toyota-shi (JP)

(73) Assignees: TOYOTA JIDOSHA KABUSHIKI KAISHA, Aichi-ken (JP); KABUSHIKI KAISHA TOKAI RIKA DENKI SEISAKUSHO, Aichi (JP)

(21) Appl. No.: 14/342,134

(22) PCT Filed: Aug. 1, 2012
(86) PCT No.: PCT/JP2012/004878

§ 371 Date: May 16, 2014

(30) Foreign Application Priority Data
Sep. 5, 2011 (JP) 2011-192987

(51) Int. Cl. H01R 13/639

(52) U.S. Cl. CPC H01R 13/6397
USPC 439/304

(57) ABSTRACT

A lock device that restricts removal of an engaging member from an engaged member includes a cover attachable to the engaging member. The cover is moved between a position covering an operation portion and a position exposing the operation portion when external force is applied to the cover. A holding unit holds the cover at the position covering the operation portion. An authentication portion releases the cover from the holding unit when authentication is accomplished.

### FIELD

The present invention relates to a lock device that restricts removal of an engaging member from an engaged member.

### BACKGROUND

An electric motor is employed as a power source or an auxiliary power source in an electric vehicle or a hybrid vehicle. A battery pack (battery), which includes a plurality of series-connected battery modules, is often used as a power source for an electric motor. Thus, whenever the state of charge of a battery becomes low in an electric vehicle or hybrid vehicle, the battery must be charged. Patent literature 1 describes an example of a system that charges a vehicle battery. In the charging system of patent literature 1, a vehicle owner possesses a power supplying connector that can be connected to, for example, a household commercial power supply or an external power supply at a charging station. The vehicle includes a power receiving connector, which is connected to the power supplying connector. When the owner connects one end of the power supplying connector to an external power supply and the other end of the power supplying connector to the power receiving connector of the vehicle, power is supplied by the connectors from the external power supply to the vehicle battery. This charges the battery. Such a structure allows the owner to charge the vehicle battery by connecting the power supplying connector to the power receiving connector of the vehicle. This improves convenience.

### CITATION LIST

### Patent Literature

[PTL 1]

Japanese Laid-Open Patent Publication No. 9-161898

### SUMMARY

### Technical Problem

A time period of a few hours to more than ten hours is required to charge a vehicle battery with power from an external power supply. Thus, in many cases, the owner will leave the vehicle. This may result in the power supplying connector being stolen.

Such a problem is not limited to the power supplying connector, which is used when charging a vehicle battery. The same problem occurs with various types of engaging members that may be removed from an engaged member by operating an operation portion.

The present invention provides a lock device that prevents theft of an engaging member.

### Solution to Problem

One aspect of the present invention is a lock device. The lock device is applicable to an engaging member that is removable from an engaged member when an operation portion is operated. The lock device restricts removal of the engaging member from the engaged member. The lock device includes a cover attachable to the engaging member. The cover is configured to be moved between a position covering the operation portion and a position exposing the operation portion when external force is applied to the cover. A holding unit holds the cover at the position covering the operation portion. An authentication portion releases the cover from the holding unit when authentication is accomplished.

In this structure, the holding unit holds the cover at the position covering the operation portion. One the holding unit holds the cover, the cover cannot be released from the holding unit unless the authentication portion accomplishes authentication. That is, operation of the operation portion is restricted until the authentication portion accomplishes authentication. Thus, after connecting the engaging member to the engaged member, the user moves the cover to the position covering the operation unit and prevents operation of the operation portion by an unauthorized person. This prevents an unauthorized person from operating the operation portion and disengaging the engaging member from the engaged member in an unauthorized manner. Accordingly, theft of the engaging member can be prevented.

The above lock device may further include a coupler attached in a removable manner to the engaging member. The cover is attached to the coupler. In this case, the authentication portion and the holding unit may be arranged in the cover and the coupler.

In this structure, the coupler may be attached to the engaging member to attach the lock device to a conventional engaging member when necessary. This improves convenience.

In the above lock device, the coupler includes a first holding member to which the cover is attached, a second holding member that holds the engaging member in cooperation with the first holding member, and a coupling member that couples the first holding member and the second holding member to each other.

In this structure, the coupler maintains the engaging member is a state held by the first holding member and the second holding member. This ensures that the coupler is fixed to the engaging member. Thus, displacement of the coupler can be suppressed. Further, for example, someone may apply external force to the lock device and move the cover (coupler) to a position exposing the operation portion. The coupler prevents such unauthorized actions and further ensures prevention of theft of the engaging member.

In the above lock device, the coupling member may include a coupler operation part operated when external force is applied. In this case, the coupling member couples and decouples the first holding member and the second holding member when external force is applied to the coupler operation part. In this structure, the coupler operation part is covered by the cover when the cover is moved to the position covering the operation portion.

This structure couples and decouples the first holding member and the second holding member when external force is applied to the coupler operation part. That is, the lock device may be attached to and removed from the engaging member just be operating the coupler operation part. Thus, convenience is improved. Further, when the cover is moved to the position covering the operation portion, the coupler operation part is also covered by the cover. In this state, an unauthorized person is prevented from operating the coupler operation part. This prevents unauthorized operation of the operation portion in the engaging member after removing the coupler from the engaging member by operating the coupler operation part. As a result, the coupler operation part improves convenience when attaching and removing the lock device, and theft of the engaging member by a third person is prevented.

In the above lock device, the holding unit may include a pin moved integrally with the cover, and a member fixed to the coupler and including a socket that receives the pin when the cover is moved to the position covering the operation portion. The holding unit holds the cover when the pin is received in the socket, and the holding unit releases the cover when the pin is removed from the socket.

In this structure, the holding unit has an extremely simple structure. This simplifies the structure of the lock device.

The above lock device may further include a wire, which couples the authentication portion and the pin of the holding unit, and an urging member, which urges the pin toward the member including the socket. In this case, when the authentication is accomplished in a state in which the pin is received in the socket, the authentication portion moves the wire to remove the pin from the socket.

This structure allows the authentication portion to be used in cooperation with the holding unit with a simple structure using the wire.

In the above lock device, the authentication portion may be formed by a key cylinder into which a mechanical key is able to be inserted. In this case, the authentication portion performs mechanical authentication based on teeth formed in the mechanical key.

This structure allows for miniaturization of the authentication portion in comparison with, for example, a dial type authentication mechanism.

In the above lock device, the cover may include an upper section that moves along the engaging member. In this case, the upper section may include a thin portion, which covers the operation portion when the cover is moved, and a thick portion, which is continuous with the thin portion and includes the authentication portion.

In this structure, the authentication portion is arranged in the uppers section of the cover. This miniaturizes the lock device and improves convenience for the user.

In the above lock device, the engaged member may be a power receiving connector arranged on a vehicle. The engaging member may be a power supplying connector connected to the power receiving connector.

The charging of a vehicle battery may take time. Thus, there is a high probability of a vehicle owner leaving the vehicle in a state in which the power receiving connector is connected to the power receiving connector. Thus, the power supplying connector may be stolen. Accordingly, the application of the above lock device to the power supplying connector prevents theft of the power supplying connector.

The above lock device may further include a restraining portion that holds the cover at the position exposing the operation portion.

In this structure, unnecessary movement of the cover relative to the engaging member is prevented.

### BRIEF DESCRIPTION OF DRAWINGS

FIG. 1 is a perspective view showing a charging system for a vehicle;

FIG. 2 is a side view showing the structure of a power supplying connector used in the charging system of FIG. 1;

FIG. 3 is a side view showing an example of the operation of the power supplying connector of FIG. 2;

FIG. 4 is a side view showing the structure of a lock device in one embodiment;

FIG. 5 is a front view showing the structure of the lock device of FIG. 4;

FIG. 6 is a perspective view showing the structure of the lock device of FIG. 4;

FIG. 7 is a perspective view showing an example of the operation of the lock device of FIG. 4;

FIG. 8 is a cross-sectional view of the lock device taken along line B-B in FIG. 5;

FIG. 9 is a cross-sectional view of the lock device taken along line A-A in FIG. 4;

FIG. 10 is a cross-sectional view showing the lock device (cover) taken along line C-C in FIG. 9;

FIG. 11A is a side view showing an example of the operation of the lock device of FIG. 4;

FIG. 11B is a cross-sectional view showing an example of the operation of the lock device of FIG. 4;

FIG. 12 is a perspective view showing how the lock device of FIG. 4 is attached to the power supplying connector;

FIG. 13 is a front view of the lock device of FIG. 4 in a state attached to the power supplying connector;

FIG. 14 is a side view showing an example of the operation of the lock device of FIG. 4; and

FIG. 15 is a cross-sectional view showing another example of the lock device of FIG. 4.

### DESCRIPTION OF EMBODIMENTS

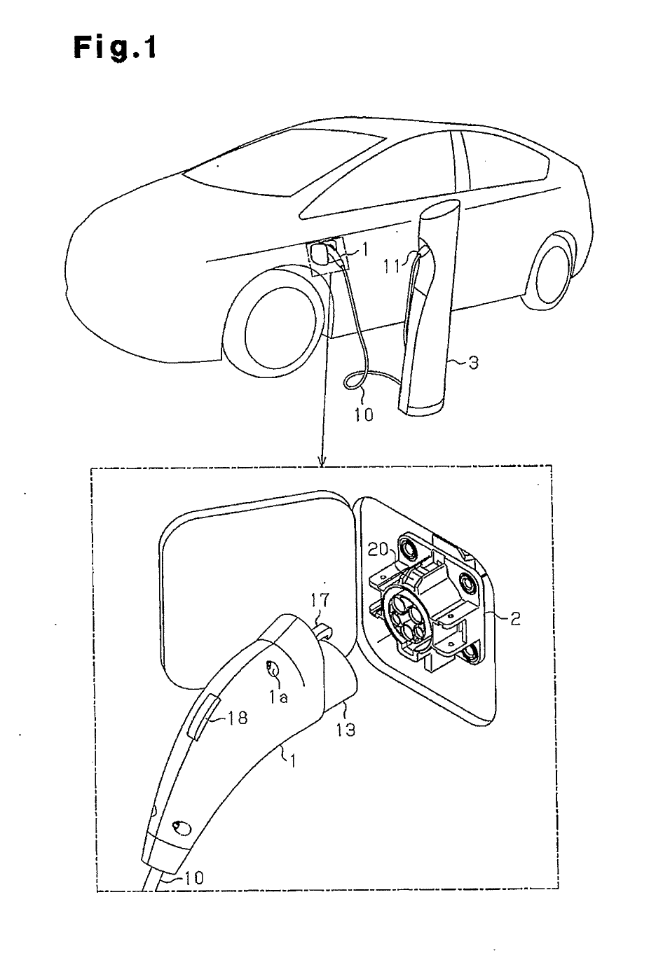

One embodiment of a lock device applied to, for example, a power supplying connector used in a charging system for a vehicle will now be described with referenced to FIGS. 1 to 14. The vehicle charging system will first be described with reference to FIG. 1. The charging system is used with a vehicle that employs an electric motor as a power source or auxiliary power source such as an electric vehicle or a hybrid vehicle.

Referring to FIG. 1, the charging system includes a power supplying connector 1, a cable 10, and a plug 11. The power supplying connector 1 is possessed by an owner. The vehicle includes a power receiving connector 2, which is connected with the power supplying connector 1. When the owner connects the plug 11 to an external power supply 3 at a charging station or the like, AC power us supplied to the vehicle from the external power supply 3 by the connectors 1 and 2. The AC power supplied to the vehicle is converted to DC power by a converter (not shown), which is installed in the vehicle. The converted DC power charges a vehicle battery (not shown), which serves as a power supply for an electric motor.

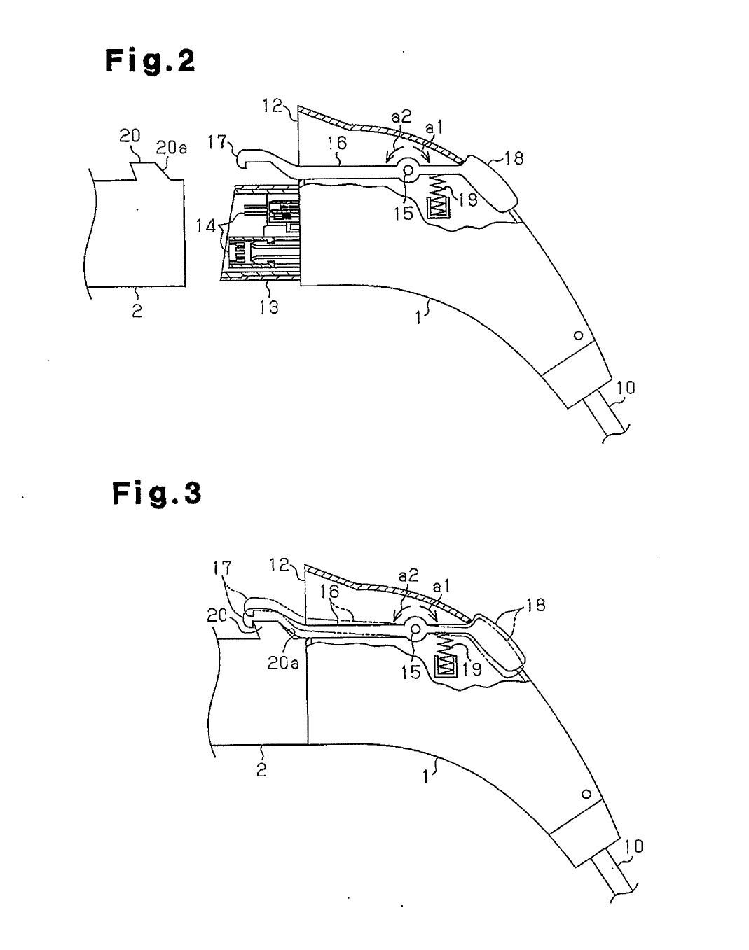

The structure of the power supplying connector 1 will now be described with reference to FIGS. 2 and 3.

As shown in FIG. 2, a connector guide 13, which can be fitted into the power receiving connector 2, projects from a distal surface 12 of the power supplying connector 1. The connector guide 13 accommodates, for example, male terminals 14, such as a power terminal, which transmits power, and a control terminal, which communicates control commands. When the connector guide 13 is fitted into the power receiving connector 2, the male terminals 14 are fitted into female terminals (not shown) arranged in the power receiving connector 2. This electrically connects the power supplying connector 1 and the power receiving connector 2.

The power supplying connector 1 includes a lock arm 16 supported by a shaft 15 to be pivotal in the directions indicated by arrows a1 and a2. One end of the lock arm 16 defines an engaging hook 17, which extends from the distal surface 12 to engage a projection 20 formed on the power receiving connector 2. The other end of the lock arm 16 defines an operation portion 18, which is exposed from a rear surface of the power supplying connector 1. The lock arm 16 is urged by a spring 19, which is arranged in the power supplying connector 1, in the direction indicated by arrow a2. This holds the arm 16 at the position shown in FIG. 2 in a state in which the operation portion 18 is in contact with an upper wall of the power supplying connector 1.

When the connector guide 13 is fitted into the power receiving connector 2, the lock arm 16 is moved in the following manner. First, when the engaging hook 17 comes into contact with the projection 20, the engaging hook 17 moves upward along a slope 20a of the projection 20. The lock arm 16 is pivoted in the direction indicated by arrow a1 against the urging force of the spring 19. When the connector guide 13 is completely fitted to the power receiving connector 2, the engaging hook 17 is engaged with the projection 20. The lock arm 16 is pivoted in the direction indicated by arrow a2 based on the urging force of the spring 19. This holds the power supplying connector 1 in a state connected to the power receiving connector 2, as shown in FIG. 3. In a state in which the power supplying connector 1 is held on the power receiving connector 2, when the owner pushes the operation portion 18 to the position shown by double-dashed lines in FIG. 3, the operation force applied to the operation portion 18 pivots the lock arm 16 in the direction indicated by arrow a1 against the urging force of the spring 19. This disengages the engaging hook 17 from the projection 20 and allows for removal of the power supplying connector 1. The power supplying connector 1 is one example of an engaging member, and the power receiving connector 2 is one example of an engaged member. Further, the engaging hook 17 is one example of an engaging portion.

In this manner, the power supplying connector 1 is fixed to the vehicle when connected to the power receiving connector 2. However, when someone operates the operation portion 18, the power receiving connector 2 may easily be removed from the power supplying connector 1. Thus, the power supplying connector 1 may be stolen.

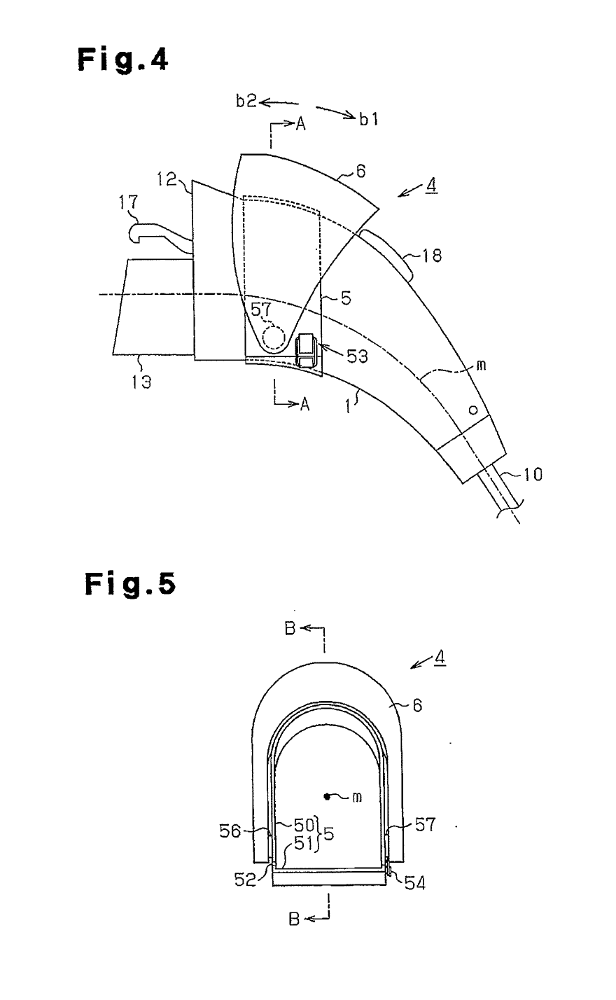

To cope with this problem, referring to FIG. 4, in the present embodiment, a lock device 4 is attached to the power supplying connector 1 to restrict operation of the operation portion 18 by an unauthorized person. The lock device 4 can be attached to the power supplying connector 1 whenever necessary. The lock device 4 will now be described in detail.

As shown in FIG. 4, the lock device 4 is attached to the power supplying connector 1 in the vicinity of the operation portion 18. The lock device 4 includes a coupler 5 and a cover 6. The coupler 5 is tubular and attached in a removable manner to the power supplying connector 1. The cover 6 covers the upper part of the coupler 5.

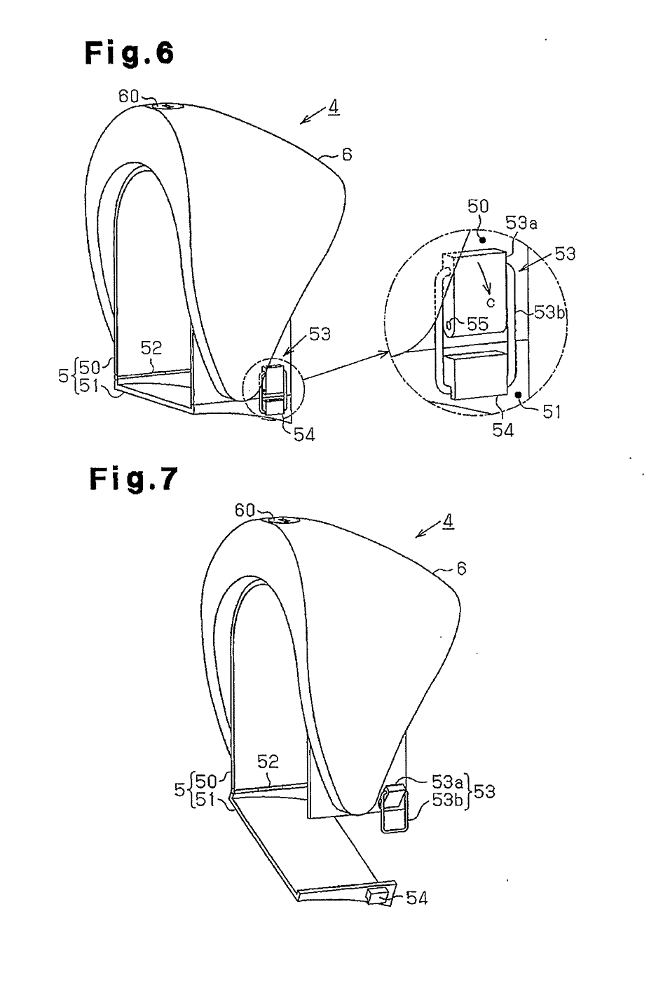

As shown in FIG. 5, which is a front view of the lock device 4, the coupler 5 includes a first holding member 50 and a second holding member 51. The first holding member 50 has a cross-section perpendicular to the axis m (FIG. 4) of the power supplying connector 1 that is U-shaped. The second holding member 51 closes the open part of the first holding member 50. A hinge 52 pivotally couples one end of the first holding member 50 and one end of the second holding member 51. As shown in FIGS. 6 and 7, which are perspective views of the lock device 4, a buckle 53 is arranged on the other end of the first holding member 50 to hold or release the other end of the second holding member 51. The buckle 53 is one example of a coupling member. As shown by the enlarged portion in FIG. 6, the buckle 53 includes a coupler operation part 53a pivotally supported by a shaft 55, which is fixed to the first holding member 50. In the present embodiment, the buckle 53 further includes a ring 53b, which is pivotally supported by the coupler operation part 53a. When the ring 53b is engaged with a hook 54 formed on the second holding member 51 with the coupler operation part 53a held at the position shown FIG. 6, the other end of the first holding member 50 and the other end of the second holding member 51 are arranged in contact and locked with each other. In this state, the application of external force to the coupler operation part 53a in the direction indicated by arrow c in FIG. 6 pivots the coupler operation part 53a about the shaft 55 in the direction indicated by arrow c. This disengages the hook 54 from the ring 53b as shown in FIG. 7. Then, the second holding member 51 is pivoted about the hinge 52 to open the lower part of the first holding member 50. The ring 53b may be omitted, and the coupler operation part 53a may be directly engaged with the hook 54.

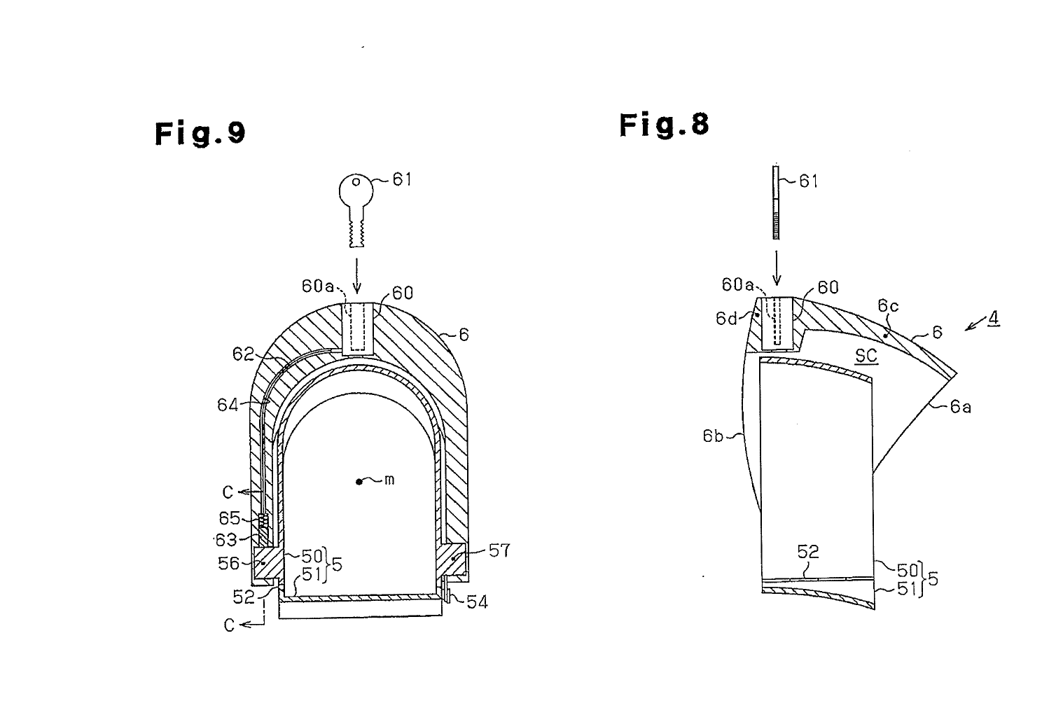

As shown in FIG. 5, the lower end of the cover 6 is pivotally supported by two shafts 56 and 57. The cover 6 pivots about the shafts 56 and 57 in the directions indicated by arrows b1 and b2 in FIG. 4. As shown in FIG. 8, which is a cross-sectional view of the lock device 4 taken along line B-B in FIG. 5, the cover 6 includes a rear surface 6a and a front surface 6b. In the upper section of the cover 6, the portion extending from the rear surface 6a to the central part defines a thin portion 6c. The thin portion 6c extends around the upper surface of the first holding member 50 with a gap SC provided in between. Further, in the upper section of the cover 6, the portion near the front surface 6b defines a thick portion 6d. In this manner, the upper section of the cover 6 includes the thin portion 6c and the thick portion 6d, which is continuous with the thin portion 6c. A key cylinder 60 is embedded in the thick portion 6d. The key cylinder 60 is one example of an authentication portion. The key cylinder 60 performs mechanical authentication with the key teeth formed on a mechanical key 61. Further, the key cylinder 60 includes a keyway 60a, which receives the mechanical key 61. The keyway 60a includes an opening exposed from the upper surface of the cover 6. Further, as shown in FIG. 9, which is a cross-sectional view taken along line A-A in FIG. 4, a wire 62 extends sideward from the key cylinder 60 through a wire hole 64, which is formed in the cover 6, to the shaft 56. When the correct mechanical key 61 is inserted into the keyway 60a and turned in a predetermined direction, the key cylinder 60 pulls the wire 62 toward the key cylinder 60.

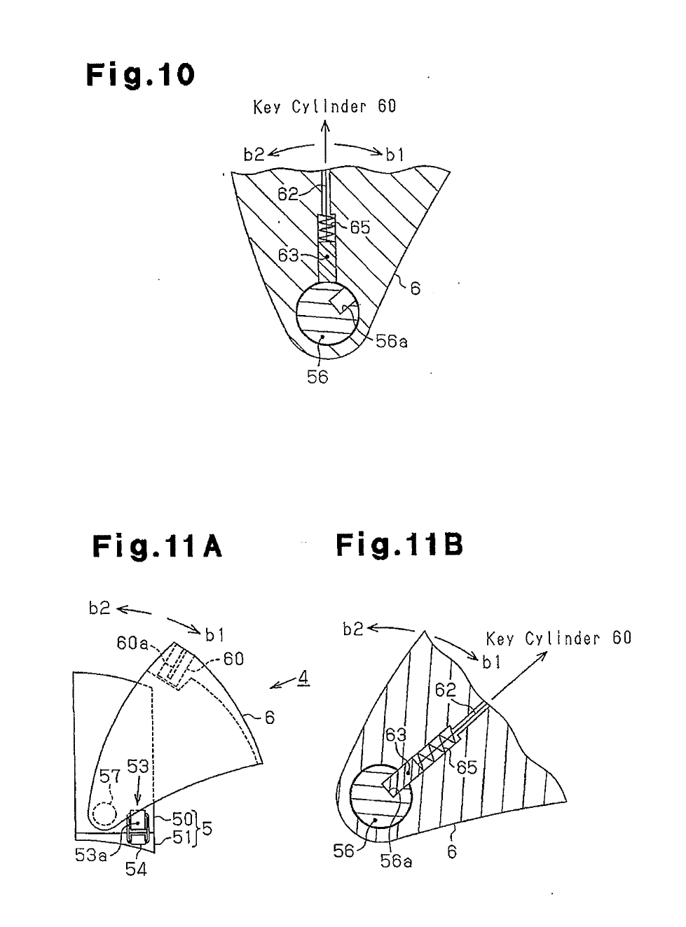

A pin 63 is arranged on a distal portion of the wire 62. The pin 63 is movable in the wire hole 64 and urged by a spring 65 (urging member) toward the shaft 56. Thus, as shown in FIG. 10, which is a cross-sectional view taken along line C-C in FIG. 9, the pin 63 contacts the circumferential surface of the shaft 56. Further, when the cover 6 pivots in the directions indicated by arrows b1 and b2, the pin 63 moves integrally with the cover 6 while sliding along the circumferential surface of the shaft 56.

As shown in FIG. 10, the circumferential surface of the shaft 56 includes a socket 56a, which receives the pin 63 when the pin 63 is rotated by a predetermined angle from the position shown in FIG. 10 in the direction indicated by arrow b1. In the present embodiment, the pin 63 and the socket 56a form a holding unit. When the cover 6 is pivoted in the direction indicated by arrow b1 to the position shown in FIG. 11A, the pin 63 enters the socket 56a as shown in FIG. 11B and restricts pivoting of the cover 6. This holds the cover 6 at the position shown in FIG. 11A. In this state, the coupler operation part 53a of the buckle 53 is covered by the cover 6. Thus, the operation of the coupler operation part 53a, that is, the removal of the lock device 4 is prohibited. Further, in the state in which the pin 63 is arranged in the socket 56a as shown in FIG. 11B, when the key cylinder 60 is operated and the wire 62 is pulled toward the key cylinder 60, the pin 63 is removed from the socket 56a. Thus, the pin 63 allows for pivoting of the cover 6.

The operation of the lock device 4 will now be described with reference to FIGS. 4 and 12 to 14. The mechanical key 61 is possessed by the vehicle owner.

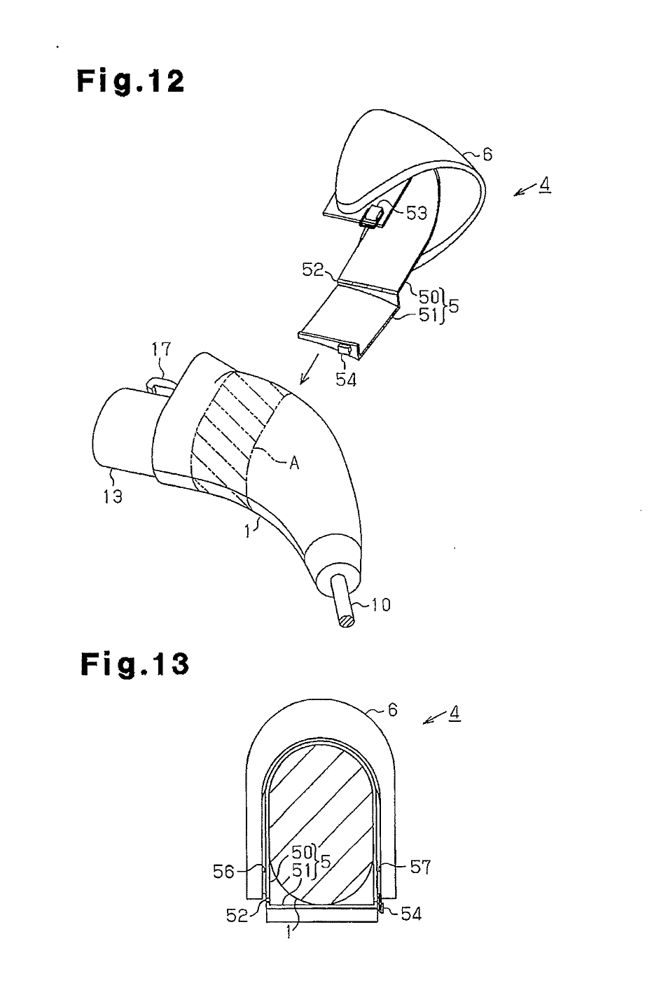

Referring to FIG. 12, when attaching the lock device 4 to the power supplying connector 1, the buckle 53 is unlocked to open the first holding member 50. As shown by the arrow in FIG. 12, after a predetermined attachment portion A of the power supplying connector 1 is fitted into the first holding member 50, the second holding member 51 is locked to the first holding member 50 by the buckle 53. This attaches the lock device 4 to the power supplying connector 1 as shown in FIG. 4. In this state, as shown in FIG. 13, the upper half of the power supplying connector 1 contacts the inner surface of the first holding member 50, and the lower part of the power supplying connector 1 contacts the inner surface of the second holding member 51. Thus, the power supplying connector 1 is held in the first and second holding members 50 and 51. That is, the lock device 4 is fixed to the power supplying connector 1 as shown in FIG. 4. Once the lock device 4 is fixed to the power supplying connector 1, the vehicle owner does not have to carry the lock device 4 separately from the power supplying connector 1. As shown in FIG. 4, the power supplying connector 1 has a diameter that increases from the attachment portion A (refer to FIG. 12), which is used by the coupler 5, toward the distal surface 12. Further, the power supplying connector 1 is curved so that the curvature increases from the attachment portion A of the coupler 5 toward the cable 10. Such a shape of the power supplying connector 1 suppresses displacement of the coupler 5.

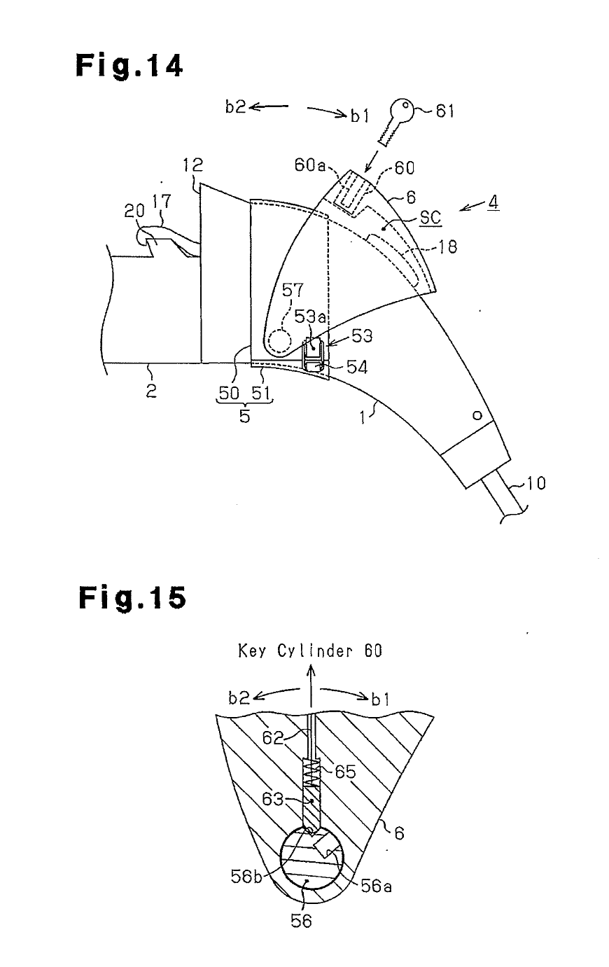

Subsequently, the engaging hook 17 of the power supplying connector 1 is engaged with the projection 20 of the power receiving connector 2 to connect the power supplying connector 1 to the power receiving connector 2. In this state, power can be supplied to the vehicle battery. Here, when external force in the direction shown by arrow b1 in FIG. 14 is applied to the cover 6 thereby moving the cover 6 to the position shown in FIG. 14, the operation portion 18 is arranged in the gap SC of the cover 6. This covers the operation portion 18 with the cover 6. In this state, the pin 63 enters the socket 56a of the shaft 56 and prohibits pivoting of the cover 6 (refer to FIG. 11B). This holds the cover 6 at the position shown in FIG. 14. In this state, the cover 6 cannot be moved unless the key cylinder 60 is operated with the mechanical key 61. That is, a person who does not have the mechanical key 61 cannot move the cover 6. Thus, operation of the operation portion 18 is prohibited. This prevents unauthorized operation of the operation portion 18 that would disengage the engaging hook 17 from the projection 20. As a result, theft of the power supplying connector 1 can be prevented. Further, the cover 6 also covers the coupler operation part 53a of the buckle 53. This prevents unauthorized operation of the buckle 53 that would remove the lock device 4 from the power supplying connector 1. Further, the shape of the power supplying connector 1 suppresses displacement of the coupler 5. This prevents unauthorized movement of the cover 6 (coupler 5) to a position exposing the operation portion 18 when an unauthorized person applies external force to the lock device 4.

When the vehicle owner inserts the mechanical key 61 into the key cylinder 60 and turns the key 61, the cover 6 can be released from the locked state, in which pivoting is restricted. Thus, by operating the operation portion 18 after moving the cover 6 to a position exposing the operation portion 18, the power supplying connector 1 can be removed from the power receiving connector 2.

The lock device of the present embodiment has the advantages described below.

(1) The lock device 4 includes the cover 6 that is moved when external force is applied between a position covering the operation portion 18 and a position exposing the operation portion 18. Further, the lock device 4 includes the holding unit that holds the cover 6 at a position covering the operation portion 18. Although the structure is not limited, the holding unit may be formed by the pin 63, which is arranged in the cover 6, and the shaft 56, which can receive the pin 63. Further, the lock device 4 includes the authentication portion that releases the cover 6 from the holding unit when authentication is accomplished. Although the structure is not limited, the authentication portion may be formed by the key cylinder 60. The key cylinder 60 is arranged in the cover 6 and releases the cover 6 when operated by the mechanical key 61. In this structure, the cover 6 covers the operation portion 18 and prevents the operation portion 18 from being operated by an unauthorized person. This prevents theft of the power supplying connector 1.

(2) The lock device 4 includes the coupler 5, which is attached in a removable manner to the power supplying connector 1 and provided with the cover 6. Thus, the lock device 4 can be attached whenever necessary to the conventional power supplying connector 1. This improves convenience.

(3) The coupler 5 includes the first holding member 50, which is attached to the cover 6, the second holding member 51, which holds the power supplying connector 1 in cooperation with the first holding member 50, and the coupling member, which couples the first holding member 50 and the second holding member 51. Although the structure is not limited, the coupling member may be formed by the buckle 53. In this structure, the lock device 4 can be attached and removed just by operating the buckle 53. This improves convenience. Further, when the lock device 4 is attached to the power supplying connector 1, the coupler 5 is fixed to the power supplying connector 1. This prevents an unauthorized person from applying external force to the lock device 4 and moving the cover 6 (coupler 5) to a position exposing the operation portion 18. This further ensures that theft of the power supplying connector 1 is prevented.

(4) When the cover 6 is moved to a position covering the operation portion, the cover 6 also covers the coupler operation part 53a of the buckle 53. This prevents an unauthorized person from operating the buckle 53 to remove the lock device 4 from the power supplying connector 1. Thus, prevention of theft of the power supplying connector 1 is further ensured while facilitating attachment and removal of the lock device 4 with the buckle 53.

(5) The pin 63 is arranged in the cover 6 and moves integrally with the cover 6. Further, the shaft 56 of the coupler 5 includes the socket 56a, which receives the pin 63. This allows the cover 6 to be held at and released from a position prohibiting operation of the operation portion 18, while simplifying the structure of the holding unit.

(6) The key cylinder 60, which performs mechanical authentication with the teeth of the mechanical key 61, is used as an authentication portion that performs user authentication. Thus, the lock device 4 can be miniaturized in comparison to when using, for example, a dial type authentication device as the authentication portion.

It should be apparent to those skilled in the art that the present invention may be embodied in many other specific forms without departing from the scope of the invention. Particularly, it should be understood that the present invention may be embodied in the following forms.

The shape of the coupler 5 may be changed in accordance with the shape of the power supplying connector. This allows the lock device 4 of the present embodiment to be attached to various power supplying connectors and improves versatility.

The lock device 4 may include a restraining structure that holds the cover 6 at the position shown in FIG. 4. FIG. 15, which corresponds to FIG. 10, shows an example of a restraining structure in which the pin 63 includes a round or conical distal portion. Further, the shaft 56 includes a groove 56b (restraining portion), which has a triangular cross-section, in addition to the socket 56a. The distal portion of the pin 63 comes into contact with the groove 56b to hold the cover 6 at the position shown in FIG. 4. In this state, the application of external force to the cover 6 in the direction indicated by arrow b1 or b2 moves the pin 63 along a sloped surface of the groove 56b and moves the pin 63 against the urging force of the spring 65 toward the wire 62. This removes the pin 63 from the groove 56b and allows the cover 6 to move in the directions indicated by arrows b1 and b2. Such a restraining structure prevents rotation of the cover 6 when the owner carries the lock device 4. Thus, the lock device 4 can be easily carried.

In the above embodiment, the shafts 56 and 57 of the coupler 5 pivotally support the cover 6. Instead, depending on the shape of the power supplying connector to which the lock device 4 is attached, the cover 6 may be supported in a slidable manner by the coupler 5.

The first holding member 50 may include a projection (or threaded portion) that is received in a threaded hole 1a shown in FIG. 1a. This ensures that displacement of the coupler 5 is prevented regardless of the shape of the power supplying connector 1.

In the above embodiment, the key cylinder 60 is used as an authentication portion that performs user authentication. However, for example, a dial type authentication device may be used in lieu of the key cylinder 60. An electronic authentication device that performs electronic authentication based on an identification (ID) code of a portable device carried by the vehicle owner may also be used in lieu of the key cylinder 60.

In the above embodiment, a structure including the pin 63 and the socket 56a is employed as the holding unit that holds the cover 6 at a certain position and releases the cover 6 from the certain position. However, any structure may be employed as the holding unit.

In the above embodiment, the buckle 53 is used as a coupling member that couples and decouples the first holding member 50 and the second holding member 51. However, any fastener can be used as the coupling member in lieu of the buckle 53.

The shafts 56 and 57 may be formed on the power supplying connector 1 to directly attach the cover 6 to the power supplying connector 1. This eliminates the need for the coupler 5 and simplifies the structure.

In the above embodiment, the lock device 4 is applied to the power supplying connector 1 that is used in a charging system for a vehicle. However, the lock device of the above embodiment may be applied to any engaging member that becomes removable from an engaged member when an operation portion is operated.

The present examples and embodiments are to be considered as illustrative and not restrictive, and the invention is not to be limited to the details given herein, but may be modified within the scope and equivalence of the appended claims.

1. A lock device applicable to an engaging member that is removable from an engaged member when an operation portion is operated, wherein the lock device restricts removal of the engaging member from the engaged member, the lock device comprising:
a cover attachable to the engaging member, wherein the cover is moved between a position covering the operation portion and a position exposing the operation portion when external force is applied to the cover;
a holding unit that holds the cover at the position covering the operation portion; and
an authentication portion that releases the cover from the holding unit when authentication is accomplished.

2. The lock device according to claim 1, further comprising a coupler attached in a removable manner to the engaging member, wherein the cover is attached to the coupler, and the authentication portion and the holding unit are arranged in the cover and the coupler.

3. The lock device according to claim 2, wherein the coupler includes:
a first holding member to which the cover is attached;
a second holding member that holds the engaging member in cooperation with the first holding member; and
a coupling member that couples the first holding member and the second holding member to each other.

4. The lock device according to claim 3, wherein:
the coupling member includes a coupler operation part operated when external force is applied and is configured to couple and decouple the first holding member and the second holding member when external force is applied to the coupler operation part; and
the coupler operation part is covered by the cover when the cover is moved to the position covering the operation portion.

5. The lock device according to claim 1, further comprising a coupler attached in a removable manner to the engaging member, wherein the cover is attached to the coupler,
wherein the holding unit includes:
a pin moved integrally with the cover; and
a member fixed to the coupler and including a socket that receives the pin when the cover is moved to the position covering the operation portion, wherein the holding unit holds the cover when the pin is received in the socket, and the holding unit releases the cover when the pin is removed from the socket.

6. The lock device according to claim 5, further comprising:
a wire that couples the authentication portion and the pin of the holding unit; and
an urging member that urges the pin toward the member including the socket,
wherein when the authentication is accomplished in a state in which the pin is received in the socket, the authentication portion moves the wire to remove the pin from the socket.

7. The lock device according to claim 1, wherein the authentication portion is formed by a key cylinder into which a mechanical key is able to be inserted, and the authentication portion performs mechanical authentication based on teeth formed in the mechanical key.

8. The lock device according to claim 1, wherein the cover includes an upper section that moves along the engaging member, and the upper section includes:
a thin portion that covers the operation portion when the cover is moved; and
a thick portion that is continuous with the thin portion and includes the authentication portion.

9. The lock device according to claim 1, wherein:
the engaged member is a power receiving connector arranged on a vehicle; and
the engaging member is a power supplying connector connected to the power receiving connector.

10. The lock device according to claim 1, further comprising a restraining portion that holds the cover at the position exposing the operation portion.

11. The lock device according to claim 1, further comprising a holding member that holds the engaging member, wherein the cover is pivotally supported by two shafts that are arranged in the holding member.
